(19) United States
(12) Patent Application Publication
(10) Pub. No.: US 2015/0002315 A1
(43) Pub. Date: Jan. 1, 2015

(54) METHOD FOR STATE ESTIMATION OF A ROAD NETWORK

(71) Applicant: SIEMENS PLC, CAMBERLEY, SURREY (GB)

(72) Inventors: Simon Box, Southampton (GB); Benedict Waterson, Southampton (GB)

(21) Appl. No.: 14/374,954

(22) PCT Filed: Jan. 28, 2013
(86) PCT No.: PCT/EP2013/051593

§ 371 Date: Jul. 28, 2014

(30) Foreign Application Priority Data
Jan. 27, 2012 (GB) 1201415.5

(51) Int. Cl. G08G 1/01; G08G 1/052

(52) U.S. Cl. CPC G08G 1/0133; G08G 1/052
USPC 340/936

(57) ABSTRACT

A method for state estimation of a road network includes at least the steps of gathering information from at least two sensors, wherein at least one of the sensors detects radio signals, combining the information from the at least two sensors using an extended Kalman filter, and determining at least one state in a discretized road network using the combined information.

The present invention presents a methodology for combining data from multiple sensors, including wireless devices, to make an estimation of the state of a road network. According to the invention, an extended Kalman filter is employed along with a state evolution model to make estimates of the state in a discretised network.

The number of wireless devices in the road network is growing rapidly. This includes smart phones carried by drivers and passengers, in-car Bluetooth systems, for example in the car radio, and increasingly in-car WiFi. Several car manufacturers are currently developing in-car WiFi systems for information, entertainment and ITS (Intelligent Transportation Systems) applications [1]. In Europe, three major studies have recently examined the benefits of vehicle to infrastructure (V2I) and vehicle to vehicle (V2V) WiFi based communications [2,3,4]. Furthermore, common European protocols are being defined for this type of communication, for example as part of the IEEE 802.11p standard.

The future trend is therefore towards a large number of different types of wireless devices in the road network. The data that may be available from these wireless devices carries valuable information that can be exploited by Urban Traffic Control (UTC) systems. Since the 1970s, it has been commonplace for urban signalized junction control systems to be vehicle actuated, i.e. sensors have been used to take measurements of the state on the roads around junctions. Data from these measurements is then being used to make informed decisions on the setting of traffic lights at these junctions.

A recent review [13] describes in detail the operation of historical and currently employed signalized junction control systems. The methods of operation of selected current systems are summarized in the following.

Microprocessor Optimised Vehicle Actuation (MOVA) [8] is currently employed on about 3000 isolated junctions in the United Kingdom [10]. It controls each junction individually, i.e. it does not coordinate the action between adjacent junctions. MOVA uses inductive loop sensors to detect vehicles approaching a junction and performs an optimization that minimizes a joint objective, which is a function of estimated vehicle delay and estimated vehicle stops.

Split Cycle Offset Optimization Technique (SCOOT) [9] is the most commonly used vehicle actuated junction controller, with installations in more than 250 towns and cities world-wide [10]. The SCOOT system coordinates the action between adjacent junctions within a “SCOOT region”. SCOOT uses inductive loop sensors to detect vehicles approaching a junction and performs three optimisation steps to adjust the timing of traffic signals: split, cycle and offset times, which are optimised at different frequencies and using different procedures [11].

Sydney Coordinated Adaptive Traffic System (SCATS) again uses inductive loop sensors to detect vehicles approaching junctions and make an estimate of the state on the road. It then uses this estimate to select a fixed timing plan from a look-up table of pre-designed plans [10]. SCATS allows for the coordination of adjacent junctions (offsets), within this framework.

One challenge is now to combine data from these new wireless data sources and existing traffic data sources, for example inductive loops [5], microwave detectors [6] or cameras [7], to estimate a single coherent image of the state of the network.

It is an object of the present invention to provide a methodology which can take such additional information available from wireless devices into account.

According to one example of the invention, a methodology for estimating a single coherent image of the state of the network is presented. The proposed methodology discretises the road network into small areas at a lane level. Metrics defining the state of the network, for example average speed V̅ or number of vehicles N, are associated with each area and estimated from multiple information sources using an Extended Kalman Filter (EKF).

The UTC systems described above all use dedicated sensors, which collect census data, i.e. vehicles are detected when passing a specific point in space. Wireless device technology can also be used to collect census data, for example using Bluetooth detectors at the roadside. However, such technology can also be used to collect probe data, for example tracking the position and speed of individual vehicles.

Trying to combine multiple independent sources of wireless and non-wireless data, which are measuring different things in different ways, can present some challenges. For example, not all of the data sources are available all of the time (latency), data from different sources may be contradictory, some vehicles may contain multiple wireless devices, others none (penetration).

The proposed methodology to meet these challenges is to employ an Extended Kalman Filter (EKF) as described in the following with reference to the figures.

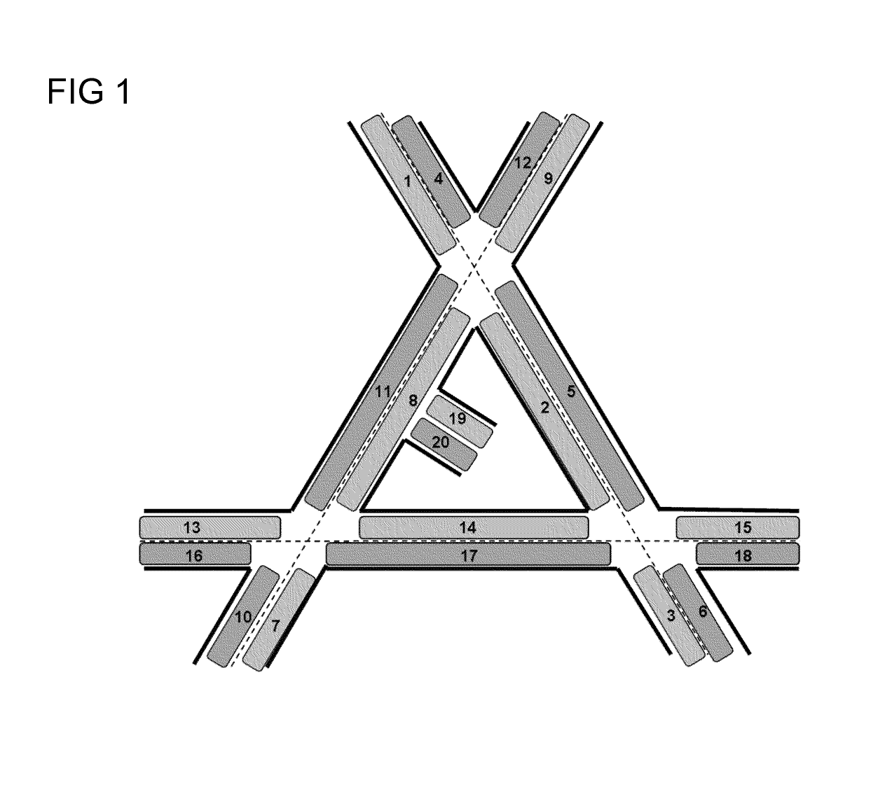

FIG. 1 shows a four junction network with three signalised junctions that is discretised into areas,

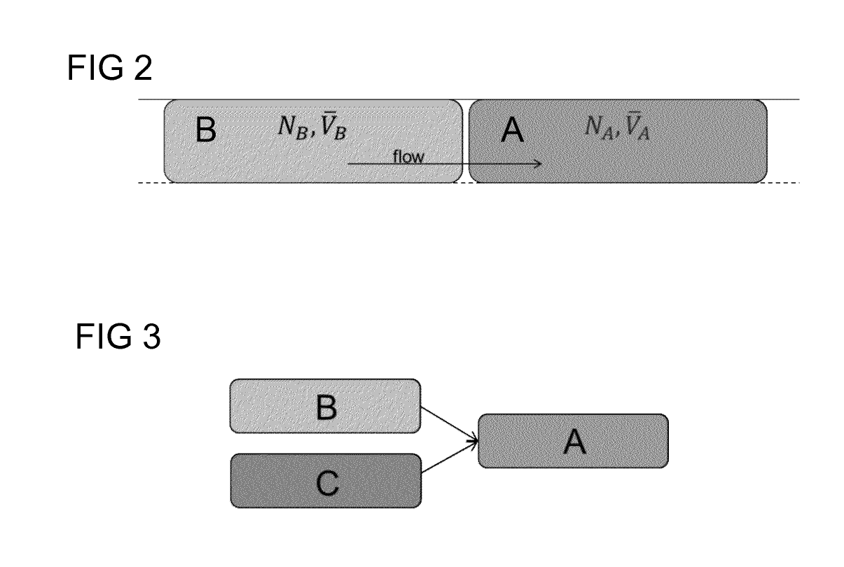

FIG. 2 shows a first state evolution model, and

FIG. 3 shows a second state evolution model.

### DEFINITION OF STATE

Within the EKF framework, we assume that no single source of information is providing the truth of the state on the road, but instead provides evidence of a state which must be defined. To define the state, the network is discretised into small areas. FIG. 1 shows the example of a four junction network with three signalized junctions, the corners of the triangle, which is discretised into areas, numbered, to define the network state. Each area has one or more metrics associated with it.

In the example of FIG. 1, two metrics are assumed: mean vehicle speed, averaged across all vehicles in the area at time t ( V̅ₜ), and number of vehicles in the area at time (Nₜ). The size andor granularity of areas may be defined in the design of the network state and tuned to provide a required level of complexity in information.

### State Evolution Model

When dynamically assessing the state of the network, it is possible to make reasonable predictions of how the state will evolve over the very short term, even in the absence of any information from sensors. This can be useful, especially during short periods of high sensor latency. An example of a simple state evolution model is presented in FIG. 2, which shows a state evolution model to predict the flow of vehicles between neighbouring areas.

Each area in a discretised network is considered individually along with its upstream neighbour. The out-flow of an area at time t(Qₜ) is estimated from V̅ₜ and Nₜ within the area using equation (1), except for the special case where end of the area corresponds with a junction stop line and the light is currently red. In this case, Qₜ=0 (1).

$${Q}_{t} = 0 at a red light \\ {Q}_{t} = \frac{{N}_{t} {\overline{V}}_{t}}{I} otherwise \qquad ( 1 )$$

wherein I is the total length of all lanes in the area.

The model estimates the state in area A at time t+1 as

N_{A,t+1}N_{A,C}+Q_{B,t}δt−Q_{A,t}δt (2)

V̅_{A,t+1}= V̅_{A,t} (3)

wherein δt the time step between t and t+1.

In the event that area A has more than one upstream neighbour, for example at a junction, the model is adjusted as in equation (4). FIG. 3 shows a state evolution model where multiple upstream neighbours are possible, for example at junctions.

N_{A,t+1}=N_{A,t}+Q_{B,t}δt+Q_{c,t}δt−Q_{A,t}δt (4)

Prediction Step

Considering a single area A, the state is defined as

Xₜ=[N_{A,t}, V̅_{A,t}] (5)

At time t+1, the state evolution model is used to make a prediction of Xₜ₊₁.

xₜ₊₁⁻=f(Xₜ) (6)

wherein the superscript (−) indicates that this is the prediction.

Larger regions containing multiple areas can also be handled using this technique. However, by considering single areas like this, the computational task can be parallelised and distributed which allows it to be deployed on networks of arbitrary size.

A covariance matrix describing the Gaussian uncertainty in Xₜ₋₁⁻ is given by

Pₜ₊₁⁻FPₜF^{T}+U (7)

wherein F is the matrix of first order partial derivatives (Jacobian) for the prediction of state function in (6). In this example, F is given by (8) below. U is a covariance matrix for the uncertainty in the state evolution model. This can be estimated, for example using a micro-simulation model.

$$F = [ \begin{matrix}\frac{\partial {N}_{A , t + 1}^{-}}{\partial {N}_{A , t}} & \frac{\partial {N}_{A , t + 1}^{-}}{\partial {\overline{V}}_{A , t}} \\ \frac{\partial {\overline{V}}_{A , t + 1}^{-}}{\partial {N}_{A , t}} & \frac{\partial {\overline{V}}_{A , t + 1}^{-}}{\partial {\overline{V}}_{A , t}}\end{matrix} ] = [ \begin{matrix}1 - \frac{{\overline{V}}_{A , t} δ t}{l} & \frac{{N}_{A , t} δ t}{l} \\ 0 & 1\end{matrix} ] \qquad ( 8 )$$

### Sensor Model

The goal of the sensor model is to estimate the sensor signals that will be received given the predicted state Xₜ₊₁⁻. The specific sensor model employed may depend on how many sensors collecting census data are in the area of interest and how many types of wireless probe sensors are currently in the network. In general, for a census sensor C₁, the expected number of counts registered on the sensor for time interval δt is modelled as

$${N}^{{C}_{1}} = \frac{{N}_{A , t + 1}^{-} {\overline{V}}_{A , t + 1}^{-} δ t}{l} \qquad ( 9 )$$

For a wireless probe sensor type W₁, the expected number of detections in area A is modelled as

N^{W}^{₁}=N_{A,t+1}⁻Φ^{W}^{₁} (10)

wherein Φ^{W}^{₁} is the penetration rate for W₁, which is the fraction of vehicles in the network carrying sensor type W₁. For some sensors, for example mobile phones, Φ^{W}^{₁} may be greater than 1.

If the wireless probe sensor W₁ can report vehicle speed, the mean speed averaged across all W₁ sensors detected in area A is modelled as

V̅^{W}^{₁}= V̅_{A,t+1}⁻ (11)

The same approach in (11) is used for census detectors that measure speed, for example inductive loop pairs.

### Update Step

In the example it is assumed that area A contains an inductive loop sensor C₁. The system currently also detects two types of wireless probe data: W₁, which provides speed data, and W₂ which does not. The measurement vector Z is given by

Z=[N^{C}^{₁},N^{W}^{₁}, V̅^{W}^{₁}, N^{W}^{₂}] (12)

y is the difference between the actual sensor measurements and the expected measurements from the sensor model (h) described above.

y=Z−h(Xₜ₊₁⁻) (13)

y is used to apply a correction to the predicted state and covariance

xₜ₊₁=Xₜ₊₁⁻+Ky (14)

Pₜ₊₁=(I−KH)Pₜ₊₁⁻ (15)

wherein H is the Jacobian matrix for the sensor model h(Xₜ₊₁⁻) and K is the Kalman gain matrix calculated according to the EKF equations [12] using

K=Pₜ₊₁⁻H^{T}(HPₜ₊₁⁻H^{T}+R)⁻¹ (16)

wherein R is a covariance matrix giving the Gaussian uncertainty in the measurement data. This can be estimated from the rated performance of the sensors.

### Implementation

The type of discretised network state described in the previous section may be used as an input to a traffic control and monitoring system, for example the Comet system [13] offered by Siemens, or evolutions thereof.

Such control and monitoring system combines data from different sources, including for example journey time, flow data provided by SCOOT, Automatic Number Plate Recognition (APNR), Bluetooth, in-car radio, location data etc. These different data sources provide information for the different sections of the road network, but may also provide different data for the same road space or area, making it difficult to determine the value that should actually be used as an input for the system. The above described methodology provides the basis to determine a value that is best suited to improve traffic flow through the road network.

Such improvement of the traffic flow can be realised in a number of ways. For example, motorists and other road users may be provided with an accurate view of the current road network state. This will encourage some road users to avoid congested areas by other diverting or delaying journeys, reducing the impact of congestion. Alternatively, the control strategies deployed by the system may be affected directly. Using a strategic control module, the available data may be used to determine traffic plans, allowing traffic to be controlled to reduce the impact of congestion. Furthermore, motorists may be informed of congestion using variable message signs, which will divert motorists to avoid congestion, thereby reducing the period of congestion. Also, operators are informed when the road conditions are significantly different to normal. This ensures that operators are focussed on the immediate needs of the road network. And as a last example, motorists may be provided with information about journey times on variable message signs, encouraging motorists to modify their regular journeys to periods when the journey time is less, for example outside the core rush hours.

With the information being more accurate than that based on single data collection methods, motorists will experience that they can trust the information which, over time, allows measures for reducing congestion to become more effective as more motorists believe and act on the advice given.

### REFERENCES

1. Bartz, D. (2009). In-Car Wi-Fi Puts ‘Infobahn’ on the Autobahn. Wired Autotopia Blog

http://www.wired.com/autopia/2009/10/in-car-internet/.

2. Kompfner, P. (2008). Cvis-cooperative for mobility. http://www.cvisproject.org/download/cvis_brochure_May2008_Fi nal.pdf.

3. COOPERS. (2010). Co-operative systems for intelligent road safety.

http//:www.coopers-ip.eu/.

4. SAFESPOT. (2010). Cooperative vehicles and road infrastructure for road safety.

http://www.safespot-eu.org/.

5. Sreedevi, I. (2005)ITSdecision services and technologies-Loop detectors.

http://www.calccit.org/itsdecision/serv_and_tech/Traffic_Sur veillance/road-based/in-road/loop_summary.html

6. Wood, K., Crabtree, M. and Gutteridge, S. (2006) Pedestrian and vehicular detectors for traffic management and control. TRL Report.

7. Lotufo, R. A., Morgan, A. D. and Johnson, A. S. (1990) Automatic number-plate recognition. Image Analysis for Transport Applications, IEE Colloquium on.(6) 1-6.

8. Vincent, G., Peirce, J.(1988) ‘MOVA’: Traffic responsive, self-optimising signal control for isolated intersections. TRRL Research Report RR170.

9. Hunt, P., Bretherton, R., Robertson, D. and Royal, M.(1982) SCOOT on-line traffic signal optimisation technique. Traffic Engineering and Control 23, 190-192.

10. Hamilton,A., Waterson,B., Cherrett,T., Robinson,A. and Snell, I. (2012) Urban Traffic Control Evolution. In Proceedings of 44^{th} Universities' Transport Study Group Conference, Aberdeen. 4-6 Jan. 2012.

11. Papageorgiou, M., Ben-Akiva, M., Bottom, J., Bovy, P. H. L., Hoogendoorn, S. P., Hounsell,N. B., Kotsialos, A. and McDonald, M.(2006) ITS and Traffic Management. Handbooks in Operations Research and Management Science, Ch 11 pp 743-754. Elsevier.

12. Zarchan, P. and Musoff, H. (2005). Fundamentals of Kalman Filtering: A Practical Approach. AIAA.

13. Siemens Mobility, Traffic Solutions.(2009) Comet modular traffic management system.

http://www.siemens.co.uk/traffic/pool/documents/brochure/com et.pdf

General reference is made to:

US 20080071465 A1

US 20110288756 A1

1-6. (canceled)

7. A method of estimating a state of a road network, the method comprising:
providing at least two sensors, including a sensor configured to detect radio signals;
gathering information from the at least two sensors;
combining the information from the at least two sensors using an extended Kalman filter; and
determining at least one state in a discretized road network using the combined information.

8. The method according to claim 7, which comprises defining a respective state for each source of information.

9. The method according to claim 7, which comprises discretizing the road network by dividing the road network it into areas (A,B,C).

10. The method according to claim 9, wherein each of the areas of the road network (A,B,C) is associated with at least one metric.

11. The method according to claim 10, wherein the at least one metric is one or both of an average vehicle speed and a number of vehicles in a respective area (A,B,C) at a given time.

12. The method according to claim 7, wherein the sensor configured to detect radio signals is a first sensor and wherein the at least two sensors also include a second sensor being a sensor selected from the group consisting of inductive loops, microwave sensors, and cameras.

13. The method according to claim 7, which further comprises inputting the at least one state in the discretized road network into a traffic control and monitoring system and implementing processes to improve a traffic flow in the road network.
